(19) United States
(12) Patent Application Publication
(10) Pub. No.: US 2009/0180646 A1
(43) Pub. Date: Jul. 16, 2009

(54) Wearable Tactile Subwoofer and Its Use

(76) Inventors: Evgeny Vulfson, Irvington, NY (US); George Whitwell, Rocky Mount, NC (US)

Correspondence Address: George Whitwell, 3251 Coley Rd, Rocky Mount, NC, 27804-8758, US

(21) Appl. No.: 11/920,812

(22) PCT Filed: May 26, 2006
(86) PCT No.: PCT/US2006/020752

§ 371 Date: Nov. 20, 2007

Related U.S. Application Data
(60) Provisional application No. 60/685,700, filed on May 28, 2005.

(51) Int. Cl. H04R 23/00

(52) U.S. Cl. 381/151

(57) ABSTRACT

This invention relates to a wearable tactile subwoofer. The invention also relates to a wearable device for listening to music and for enhancing other audio and audio including experiences and a method of listening to music and enhancing other audio and audio accompanied experiences in humans.

### TECHNICAL FIELD

The present invention relates to a wearable tactile subwoofer. This invention also relates to a wearable device for listening to music and for enhancing other audio and audio accompanied experiences and a method of listening to music and enhancing other audio and audio accompanied experiences in humans.

### BACKGROUND ART

Accurate reproduction of sound across the spectrum of audible frequencies, typically from about 20 Hz to about 20 KHz, is required in a variety of consumer electronic devices and computers. Typically, this frequency spectrum is divided up into several bands or groups of frequencies with each band being “handled” by a specific driver that is well suited to reproduce it accurately. For example, the high frequency sound above 2,000 Hz may be given to a tweeter, while the frequencies from 200 Hz up to 2,000 Hz may be transmitted by a midrange driver, and subwoofer would then take over at around 200 Hz and below. Stand-alone subwoofers dedicated to accurate reproduction of low frequency sound, typically from about 20 Hz to about 200 Hz, have become increasingly popular in recent years among those consumers who regularly listen to music or seek to enhance other audio and audio accompanied experiences.

Typically, subwoofers contain relatively large and heavy cones, placed into relatively big acoustic cabinets and require a powerful amplifier to drive them adequately. This is because the declining sensitivity of the human ear in the low frequency range, the attenuating nature of air, and the very long wavelengths of the sound radiating at low frequencies, all combine to require the subwoofer to match the intensity of sound provided by other speakers in the rest of the audible spectrum. For these and other reasons, which are well known and understood, the manufacture of small subwoofers is exceedingly difficult. Nevertheless, there is a clear need for such a subwoofer because more and more people are listening to the music or playing games using portable devices such as CD and MP3 players, game consoles and cell phones, and often on the move.

To address this need, the industry has developed various “high end” headphones, where the low frequency response is somewhat improved through the design of more efficient drivers or by using so-called psycho-acoustic algorithms to provide a greater perception of the bass. However, poor response in the low frequency range remains as one of the most significant limitations in the quality of mobile audio. It is a primary object of the present invention to overcome this limitation by providing a wearable tactile subwoofer, which is designed for listening to music and for enhancing other audio and audio accompanied experiences, and a device and a method of listening to music and enhancing other audio and audio accompanied experiences.

It is well-known that human skin is sensitive to and can perceive sound waves in a low frequency range, typically from about several hertz to hundred(s) hertz, but it was a surprise to discover that when conventional audio, e.g. as provided through headphones is combined with the tactile subwoofer, which is mechanically coupled to the skin, various audio and audio accompanied experiences, such as listening to music and others can be substantially enhanced.

### DESCRIPTION OF PRIOR ART

Numerous vibration devices designed to enhance video and audio experience by transmitting low frequency sound and vibrations to the body, typically in amusement parks, movie theaters and home theaters, are well known.

U.S. Pat. No. 3,366,749 discloses a transducer converting electrical signals received from a sound source into conforming vibration of a post on which the said transducer is mounted with a screw. The vibration of the post is felt by the body. This is a bulky device that requires special installation in a chair or the like to provide good mechanical coupling between the vibrating surface and the body.

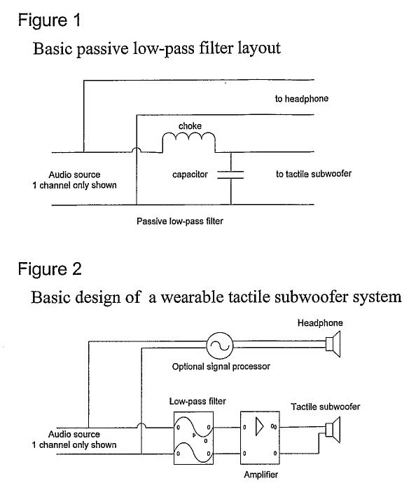

U.S. Pat. No. 4,750,208 improves on the electromechanical vibration converter disclosed in U.S. Pat. No. 3,366,749 by providing a specially designed casing or enclosure. The device provided in U.S. Pat. No. 4,750,208 can transmit a body-felt vibration to a commercially available chair or the like without the need for prior installation and, according to the inventors, causing no sitting discomfort. This is also a bulky device explicitly designed for sitting on as illustrated by the use of the device in, for example, FIG. 13 of the said invention.

U.S. Pat. No. 6,139,324, U.S. Pat. No. 6,585,515 and U.S. Pat. No. 6,662,560 assigned to D-box technologies (http://www.d-box.com/) and references cited therein disclose a system that produces movements in the home entertainment chair, the system comprising a motor controller and a plurality of movement generator units. The system is installed under the legs of a chair or a sofa.

Several companies have successfully commercialized devices based on the principle described in the above and similar inventions. For example, The Guitammer Company Inc (http://www.thebuttkicker.com/), Pyramat (http://www.pyramat.com/), and Clark Synthesis Inc (http://www.clarksynthesis.com/) manufacture and sell “sound” furniture for enhancing video and audio experience typically in a home theater setting and in PC gaming. These products may provide some mechanical coupling between the vibrating surface and the skin by virtue of, for example, standing, sitting or lying on them or objects to which they are attached. However, none of these devices are wearable.

Relatively small, so-called portable, subwoofers that can be carried around are also known and commercially available from several well-known manufacturers. Also, devices for carrying subwoofers around are known. For example, U.S. Pat. No. 4,412,106 discloses an audio system for portable high fidelity reproduction of sound, which is designed to be supported by or built into an interconnecting belt-like garment. This system comprises numerous components including a conventional subwoofer, which is referred to in U.S. Pat. No. 4,412,106 as “bass reproduction device”. The said bass reproduction device is attached to a support to wear it on the body. Such device may make it more comfortable or convenient to the listener to carry a conventional subwoofer around. However, this and similar carrying devices do not provide for mechanical coupling between the subwoofer and the body or the skin of the user.

Wearable vibration devices designed for listening to music and for enhancing of audio related experiences are also known and commercially available. A typical example is vibrating headphones, which, as the name of this and similar devices suggest, are designed to vibrate on the user's head. Such devices are not designed to accurately reproduce and transmit low frequency sound by tactile means and they do not contain or otherwise incorporate the tactile subwoofer as disclosed herein.

A variety of other vibration devices for enhancing audio and visual experience that come into direct contact with human body or skin are also known and commercially available. Typically, these are gaming devices such as trembling and/or vibrating joysticks in PCs and game consoles, PC mouse, and the like. Such devices are designed for creating special effects for the gamers simulating sensations such as, for example, shaking, trembling, falling and the like. These devices are not design for accurate reproduction of low frequency sound and they do not contain or otherwise incorporate the tactile subwoofer as disclosed herein.

Numerous tactile devices for the deaf or people with severely impaired hearing are well known and are available commercially. Many such devices are wearable and some contain small skin transducers which can be worn on the wrist, chest or around the back of the neck. Typically, these transducers are resonant at a single frequency at about 250 Hz. In more advanced devices a number of such transducers can be used e.g. in the form of a tactile array, where each transducer is assigned to a different frequency band. In these systems the sound signal is typically separated into segments or bands by a processor and each segment is presented at a different location on the skin.

The fundamental concept underlying all such devices is to provide the deaf or people with severely impaired hearing with access to information that is unobtainable to them or which is difficult to obtain by other means. Thus, these devices are essentially medical devices, while the wearable tactile subwoofer disclosed herein provides an entertainment device, which is designed for listening to music and for enhancing other audio and audio accompanied experiences. It is explicitly understood that the wearable tactile subwoofer disclosed herein is not meant to be or construed as a hearing aid or the like.

Numerous tactile devices for the blind or people with severely impaired vision are also well known and are available commercially. Typically, such a device is a tactile display that can be a vibration tactile display. The fundamental concept underlying all these devices is to provide the blind or people with severely impaired vision with access to information that is unobtainable to them or is difficult to obtain by other means. Thus, these devices are essentially medical devices, while the wearable tactile subwoofer disclosed herein provides an entertainment device, which is designed for listening to music and for enhancing other audio and audio accompanied experiences. It is explicitly understood that the wearable tactile subwoofer disclosed herein is not meant to be or construed as a vision aid or the like.

Numerous devices designed for generating a vibration or inertial signal that may be felt or sensed with or without producing an audible sound are also well known and commercially available.

These devices are typically used in cell phones, pagers, wearable computers and the like, as exemplified by U.S. Pat. No. 6,618,206 and references cited therein. These devices are design to alert the user to a signal or an event by tactile rather than audio stimulation. Such devices can be wearable. For example, a head mounted display apparatus capable of generating and detecting vibrations is disclosed in U.S. Pat. No. 5,986,813. The design and purpose of the said device is vibrating in response to an input of a caution signal for alerting the user.

Numerous vibro-tactile feed-back devices are also known in prior art, as exemplified by U.S. Pat. No. 6,088,017, U.S. Pat. No. 6,275,213 and U.S. Pat. No. 6,424,333 and references cited therein. The subject of these and similar inventions is the provision of a man-machine interface to provide a tactile feedback to various sensing body parts. These devices are typically used in the design and operation of various virtual reality systems and robotic systems to simulate the shape and/or the texture of the object in the course of human's interaction with a computer. The general purpose of these and similar apparatuses and devices is to facilitate various interactive computing applications.

Relatively flat and flexible subwoofers are also known in the art such as those used in car entertainment systems, as exemplified in U.S. Pat. No. 6,639,988. However, the subwoofer disclosed in U.S. Pat. No. 6,639,988 is not wearable and the said subwoofer is not designed to provide tactile sensation to humans through coupling to the human body.

An artificial “extension” of bass frequencies using various so-called psychoacoustic effects, such as those disclosed in U.S. Pat. No. 5,930,373 issued to Waves Ltd, is also known and commercially available e.g. the MaxxBass algorithm and technology and the like. All these technologies are distinctly different from the wearable sub-woofer in that the synthesized audio frequencies provided by their algorithms are in the range of normal hearing and being harmonic overtones of the “missing” very low frequencies are substantially or exclusively perceived through the ears and not through the skin.

It is a primary object of the present invention to provide a wearable tactile subwoofer for accurate reproduction of sound frequencies from about 5 Hz to about 500 Hz, where the said subwoofer is mechanically coupled to the human skin. It is also an object of the present invention to provide a wearable device for listening to music and for enhancing other audio and audio accompanied experiences and a method of listening to music and enhancing other audio and audio accompanied experiences in humans.

### DISCLOSURE OF INVENTION

This invention provides a wearable tactile subwoofer for accurate reproduction of sound frequencies in a range from about 5 Hz to about 500 Hz, wherein said subwoofer is mechanically coupled to the body or is part of a garment of clothing, or a clothing accessory, or a personal accessory or jewelry. According to this invention the tactile subwoofer disclosed herein preferably comprises at least two components, where the first component is the coupling component, and the second component contains an electromechanical device or devices that convert electric signals into mechanical vibrations to generate and transmit sound waves in the desired frequency range, and where the mechanical coupling of the said subwoofer to the human body is established predominantly through the coupling component.

This invention also provides a wearable device for listening to music and for enhancing other audio and audio accompanied experiences; the said device comprising at least two components:
(i) a tactile subwoofer for accurate reproduction of sound waves with frequencies from about 5 Hz to about 500 Hz, wherein said subwoofer is mechanically coupled to the body, or is part of a garment of clothing, or a clothing accessory, or a personal accessory or jewelry and
(ii) a set of speakers consisting of at least one speaker for accurate reproduction of sound with frequencies from about 20 Hz to about 20 KHz;
   and wherein
(a) the said tactile subwoofer and the said speakers are connected to the same audio source and transmit the same audio program and
(b) the output of the said subwoofer and speakers can be separately controlled and adjusted with independent output controls.

According to this invention it is preferable to have a substantial overlap in the frequency range delivered by the said tactile subwoofer and the said speakers.

This invention also provides a method of listening to music and enhancing other audio and audio accompanied experiences in humans, the method comprising:
(i) connecting (1) a set of wearable speakers consisting of at least one speaker capable of accurate reproduction of sound waves with frequencies from about 20 Hz to about 20 KHz and (2) at least one wearable tactile subwoofer capable of accurate reproduction of sound waves with frequencies from about 5 Hz to about 500 Hz, where the said subwoofer is mechanically coupled to the body of the said human, and
(ii) simultaneously receiving and independently adjusting the output from the said speaker and the said subwoofer in such a way as to produce a realistic audio experience, while causing no substantially audible interference with and disturbance to other humans in a reasonable vicinity, regardless of whether the said humans are also practicing the method or not.

### DETAILED DESCRIPTION OF THE INVENTION

In one embodiment this invention provides a wearable tactile subwoofer for accurate reproduction of sound frequencies in a range from about 5 Hz to about 500 Hz, where the said subwoofer is mechanically coupled to human or animal body, preferably to the skin.

For the purpose of this invention “mechanical coupling” is understood to mean the presence of a contact area between the surface of the tactile subwoofer and the surface of the human or animal body such that the loss of sound energy transmitted from the subwoofer into the body, is substantially reduced at the interface between the said subwoofer and the body.

The presence of such a mechanically coupled interface is one of the defining features of the tactile subwoofer of the present invention because unlike other subwoofers known in the prior art, the tactile subwoofer disclosed herein is very efficient at transferring sound energy into the body by directing the sound primarily or directly into the body and by reducing the attenuation.

It is preferable that the tactile subwoofer of the present invention, or at least a part or the surface of the said subwoofer, which is in contact with the human or animal body, is deformable and/or elastic so that it can conform to the profile or curvature of the body to establish good mechanical coupling and the efficient energy transfer.

In accordance with this invention the tactile subwoofer preferably comprises at least two components, where the first component is the coupling component, and the second component contains an electromechanical device or devices that convert electric signals into mechanical vibrations to generate and transmit sound waves in the desired frequency range, and where the mechanical coupling of the said subwoofer to the human or animal body is established predominantly through the coupling component.

The said two components can be manufactured as a single piece or as separate pieces, so that, for example, they are connected when the tactile subwoofer of the present invention is assembled e.g. at the manufacturing plant or at a retail outlet selling the said subwoofer or by the end users themselves. If manufactured in two or more pieces, it is preferable that the coupling component is detachable and replaceable, and that such a detachment and replacement can be accomplished with relative ease, so that the end user can dispose of the said coupling component after a period of time for hygienic, esthetic or any other reason, and replace it with the same or similar coupling component, in accordance to his or her preference and desire, and without undue effort.

A layered or sandwiched structure, where one component is positioned substantially on top of another component is preferred. It is explicitly understood that the constituent components can penetrate into one another and can otherwise connect to each other or otherwise interact with each other, when forming the subwoofer of the present invention.

The coupling component can be a solid, predominantly solid or contain a substantial amount of liquid, preferably confined within a sealed housing or a chamber in the form of, for example, a pad comprising a layer or layers of membrane or film or the like or other material which is capable of containing the said liquid within the said pad, chamber or housing. The liquid can be water, or a mixture of water with other non-hazardous liquids, preferably the liquids with a higher viscosity than water such as, for example, (poly)glycerol and (poly)ethyleneglycol and the like, or a solution or suspension of non-hazardous solids in water, such as various natural and synthetic polymers and the like. Solutions and suspensions with viscosity higher than water are generally preferred.

The coupling component is preferably solid or largely solid material, preferably a polymer, preferably a hydrophilic polymer, preferably a cross-linked hydrophilic polymer such as, for example, numerous hydrogels, which are well-known in medical practice and chemical and biological research. Many such materials are commercially available as polymers or as precursor monomers that can be polymerized and/or otherwise processed by well-known and established methods.

In accordance with this invention a variety of such polymers can be successfully employed. For example, (poly)vinyl alcohol, (poly)vinylpyrrolidone, (poly)ethyleneglycol, (poly)propyleneglycol, (poly)glycerol and other polyalcohols, and poly(meth)acrylic acid, poly(meth)acrylic acids and salts and derivatives thereof such as, various poly(meth)acrylamide and poly(meth)acrylamide and the like and the mixture and combinations thereof can all be used successfully to practice this invention. Various long chain polysaccharides such as carrageenan, locust gum and other natural gum, alginic acid and alginate derivatives, starch and cellulose and their derivatives such as, carboxymethyl cellulose, hydroxyalkylcellulose, chitin and its derivatives, and other natural or chemically modified polymers, or synthetic polymers, random or block polymers can all be used successfully.

This is by no means an exhaustive list and other polymers and pre-polymers and polymer forming precursors such as, for example, any of the constituent monomers of the polymers mentioned herein, and (poly)urethane and (poly)silicone, and various known hydrogels can all be fruitfully employed to successfully practice the present invention, provided that they are not hazardous to humans and, preferably do not cause undesirable reactions on wearing such as, for example, allergy, eczema and the like.

It is preferred to have the coupling component of the present invention to have a density similar to or at least not too different from the density of the human body i.e. the density of about 1 g/cm³.

The second component of the wearable tactile subwoofer of this invention contains an electromechanical device or devices that convert electric signals into mechanical vibrations to generate and transmit sound waves in the desired frequency range. The said electromechanical device can be a conventional electromagnetic or electrostatic device or devices with conventional diaphragms commonly used in such devices, which can be assembled in conventional drivers, such as typical dynamic drivers. The said electromechanical device or devices can also contain or incorporate ceramic piezoelectric materials such as, for example various metal oxide structures e.g. lead zirconate titanate and the like, or polymeric piezoelectrics such as, for example, polyvinylidene difluoride and the like, or various Micro-Electro-Mechanical Systems (so called MEMS)-based microspeakers, or any mixture or combination thereof. Such devices are well known and many are commercially available.

It is explicitly understood that in the context of this invention, the disclosed two components are defined in functional terms i.e. what they do to make the subwoofer of the present invention to function properly. Such a description does not mean or otherwise imply that the said two components must be physically different or separable entities. Those skilled in the art would instantly recognize that a great many ways and means of combining the two components exist, many of which are well known in the art.

It is preferred to manufacture the wearable tactile subwoofer of the present invention in such a way that at least one of above mentioned components, preferably the coupling component, or at least a part of the coupling component, which is in contact with the body or skin, is flat or substantially flat.

For the purpose of this invention “flat” is understood to mean an object with an average height being appreciably smaller than either the length or width. It is preferable that the average height of the said component or its part is from about 5 to about 200 times smaller than the either the length or width, preferably from about 10 to about 100.

It is preferred to manufacture the wearable tactile subwoofer of the present invention in such a way that there is a reasonable area of contact between the said subwoofer, preferably between the coupling component, and the human body, preferably the skin, the said contact area is a range from about 0.1 cm² to about 5,000 cm², preferably from about 1 cm² to about 500 cm², preferably from about 5 cm² to about 100 cm². The said contact area does not have to be continuous or single. It is explicitly understood that the subwoofer of the present invention may have any number of contact points with the body, where the said number is equal to or higher than one. It is preferable that the said contact area or in other words the side of the subwoofer, which is in contact with the body, is reasonably smooth or appears smooth on touching.

The surface area and dimensions as disclosed herein do not mean or otherwise imply that the two or more components of the tactile subwoofer of the present invention must be of the same dimensions or have the same surface area. It is explicitly understood that the surface area and dimensions of any component or any part of the component can be the same or different or substantially different from other components or parts; it can be smaller or bigger, flat or otherwise as compared to other parts.

Another defining feature of the tactile subwoofer of the present invention is its wearability.

For the purpose of this invention “wearability” is understood to mean the ability to wear an object as a garment of clothing or clothing accessory or a personal accessory or jewelry or the like in accordance with generally accepted habits and cultures.

It is explicitly understood that the ability to “wear” an object is distinct and different from the ability to move or carry an object. For example, humans can move a chair or a piece of furniture containing a tactile subwoofer and attach themselves to the said chair or the piece of furniture but they do not normally wear chairs or pieces of furniture as clothing or clothing accessories or a personal accessory or jewelry. Similarly, humans may carry conventional or portable subwoofers, and position them in appropriate or convenient places, and mechanically couple themselves to the said subwoofers at the place of their choosing by, for example, holding it very tightly with their hands or sitting on it, but humans do not normally wear subwoofers, as they are known in the prior art, as clothing or clothing accessories or a personal accessory or jewelry.

The tactile subwoofer of the present invention can optionally comprise yet another (third) component, preferably in a form of a decorative (or otherwise esthetically pleasing) layer or a cover. It is preferred to manufacture the said component from a material, which lends itself to manufacturing in different colors, textures, or shapes, such as for example, plastic, wood, metal, textile and the like, and any modification of these materials, and any combinations thereof, so that the tactile subwoofer of the present invention or any wearable object as defined herein, which may incorporate or otherwise include the said subwoofer would coordinate in color, texture or shape with the clothing, or clothing accessories, or a personal accessory or jewelry or the like, that the user may be wearing time to time.

The said optional component can be manufactured and sold as an integral or constituent part of the wearable tactile subwoofer of the present invention or as a removable and replaceable part or cover of the said subwoofer, or separately as an accessory to the said subwoofer. The said component is preferably removable and replaceable.

It is explicitly understood that regardless of whether such a component is manufactured as an integral and inseparable part of the subwoofer of the present invention or is manufactured separately in the form of, for example, a cover or an accessory, it is a constituent component of the subwoofer as disclosed herein and as such it is included in the present invention.

Those skilled in the art would instantly appreciate that the design of the tactile subwoofer disclosed herein is very different from any other subwoofer design known in the prior art. For example, typical subwoofers contain decorative panels of various colors, textures, and shapes to make them esthetically pleasing to humans. Such panels are typically located on the front of the subwoofer or, in other words, such panels are located between the sound generating/transmitting assembly of the subwoofer and the listener. The design disclosed herein is entirely different because the optional component disclosed above, which is a wearable equivalent of decorative panels of conventional subwoofers, is positioned on the opposite side, i.e. on the side which would normally be considered the back of the subwoofer.

It is preferable to manufacture the tactile subwoofer of the present invention in such a way that it can be worn reasonably close to skin so that the said subwoofer is mechanically coupled to the skin as defined herein, preferably in contact with the skin, preferably directly on the skin.

It is preferred to manufacture the said subwoofer in a form of or be incorporated in a garment of clothing or clothing accessory or personal accessory or jewelry such as, for example, a cap, or a headband, or a bracelet or as medallion. These examples are not intended to be limiting in any way and those skilled in the art would instantly recognize that the subwoofer of the present invention can also be manufactured in the form of or be incorporated into a great many other objects that may be worn by humans time to time under certain conditions or when exercising certain activities such as, for example, sport accessories e.g. wrist bands and racquets and the like, hair accessories e.g. various combs and hair clips and the like, or sunglasses, or suspenders and the like. The tactile subwoofer of the present invention can also be manufactured as a patch to be worn on the skin in any locality of the human body, depending on the user's preferences and desire. It is recognized that while such preferences can be highly individualized in practice, e.g. one may like to use the sub-woofer on the head and another like the arm, there will be generally preferred placements that will appeal to a large segment of users. For example, some users may prefer to wear the subwoofer on their chests (e.g. as a medallion), breasts (e.g. bra or be incorporated into a bra) or on the chest and the back since such locations provide a large surface area for coupling.

It is explicitly understood that the wearability of the tactile subwoofer disclosed herein does not mean or otherwise imply any restriction on when and how it can be worn or used. For example, there is no requirement to wear any specific clothing, or clothing accessory or a personal accessory or jewelry to be able to use the tactile subwoofer of the present invention, unless the tactile subwoofer itself is manufactured as clothing or a garment of clothing. Furthermore, naked people can also successfully use the tactile subwoofer this invention, provided that the said subwoofer is mechanically coupled to the body and is appropriately connected to an audio source.

The tactile subwoofer of the present invention is designed primarily for humans but those skilled in the art would instantly recognize that it can also be used successfully on animals for a variety of purposes such as, for example, to convey information to the said animals, for example in the form of a command, using low frequency tactile signals rather than by conventional ways and means, including but not limited to calling, shouting, whistling and transmitting any other audible signals.

In another embodiment this invention provides a wearable device for listening to music and for enhancing other audio and audio accompanied experiences; the said device comprising of at least two components:
(i) a tactile subwoofer for accurate reproduction of sound waves with frequencies from about 5 Hz to about 500 Hz, wherein said subwoofer is mechanically coupled to the body, or is part of a garment of clothing, or a clothing accessory, or a personal accessory or jewelry and
(ii) a set of speakers consisting of at least one speaker for accurate reproduction of sound waves with frequencies from about 20 Hz to about 20 KHz;
   and wherein
(a) the said tactile subwoofer and the said speakers are connected to the same audio source and transmit the same audio program and
(b) the output of the said subwoofer and speakers can be separately controlled and adjusted with independent output controls.

In the context of this invention “audio accompanied experiences” is understood to mean experiences where sound plays a significant part in the overall experience and where its exclusion or inaccurate reproduction would diminish the said overall experience. For example, in accordance with this invention watching movies or other video/audio programming or playing games on a PC or a game console is explicitly an audio accompanied experience.

The wearable device disclosed herein has a number of unique and distinct features that distinguish it from any other wearable devices designed for listening to music and for enhancing other audio and audio accompanied experiences, such as conventional headphones, speakerphones, ear-buds and the like. For example, the conventional headphones and the like may incorporate various technologies and hardware such as new or advanced cones and vibrating films and drivers designed to reproduce the low frequency sound with more power, or accuracy or in a wide range of frequency. Also, these conventional devices and/or the audio source for driving them may incorporate various algorithms for artificially enhancing bass e.g. by fooling the brain into thinking that it hears more than it actually does. However, all these devices are designed in such a way as to transmit the sound into at least one human ear, typically both, whereas the device disclosed herein is designed to transmit the low frequency sound into the user's body, through the skin, by incorporating a tactile subwoofer, preferably the tactile subwoofer of the present invention. It is explicitly understood that that the device of the present invention may optionally incorporate any or all of the above said audio enhancing technologies and the like and any other hardware- and software-based enhancements, and all such devices are the subject of this invention.

Another distinct feature of the wearable device disclosed herein is that it is designed to integrate easily and seamlessly a sound signal with frequencies from about 20 Hz to about 20 KHz, which is targeted at or transmitted into the human ear(s), with a tactile signal with frequencies from about 5 Hz to about 500 Hz, which is targeted at and transmitted into the human body through the skin, where the said two signals are derived from the same audio source and can be controlled and adjusted independently, preferably separately, to enhance the audio and audio accompanied experiences.

The latter is an important and defining feature of the device because not only the ears of different individuals have different sensitivity to sound and the skin of different individuals has different sensitivity to tactile signals and stimulations but also because the same individual can have relatively sensitive ears and a relatively insensitive skin or relatively insensitive ears and a relatively sensitive skin or combine these characteristics in any other permutations. The wearable device of the present invention is the only known device that enables the user to control and adjust the audio signal and the tactile signal independently, preferably separately, in accordance with the user's physiology and preferences, thus providing an unprecedented enhancement of various audio and audio accompanied experiences.

It would be instantly understood and appreciated by those skilled in the art that the audio and audio accompanied experience attainable through the use of the device disclosed herein is substantially different from that attained by simply hanging on or otherwise attaching to the listener one or more conventional speakers and subwoofers (even if these are somehow made to be wearable and even if these are independently adjustable) because, at least in part, such an assembly of speaker(s) and subwoofer(s) does not enable the said listener to feel and appreciate the “touch” of the music and other sounds by the specific locality of the body or the skin to which the tactile subwoofer component (i) of the present device is mechanically coupled to.

Yet another feature that distinguishes the device of the present invention from numerous other headphones, speakerphones, ear-buds, and the like is that in the latter the low frequency sound as defined herein and sound of the rest of the audio range are typically generated within the same housing or enclosure or assembly. Such a design is predicated on the targeting the ear of the listener as a receiver of the sound waves that are generated by conventional headphones and the like, while the device disclosed herein has no such constraints.

The device disclosed herein can be designed and manufactured as a single unit or in such a way as to physically separate the two constituent components i.e. the tactile subwoofer (i) and the set of speakers (ii), and such a separation is preferred. For example, while it is desirable to design the speaker component (ii) to be positioned in the vicinity of the human or animal ear, the position of the tactile subwoofer component (i) as defined herein may vary substantially. Thus, the tactile subwoofer component (i) can be positioned, for example, on the forehead, or around the head in the form of, for example, a headband, or on the arms, or the wrists in the form of, for example, armbands or wristbands, or on the back of the neck, or on the chest or on the back or on the legs on any side of the body as, for example, a patch.

In accordance with this invention the distance between the tactile subwoofer component (i) and the speaker component (ii) can be about a few tenths of an inch, or about a few inches, or about a foot or about a few feet, as preferred or desired. Furthermore, in accordance to this invention the tactile subwoofer component (i) can be positioned at some distance from the human and animal ear. Such a distance can be about a few tenths of an inch, or about a few inches, or about a foot or about a few feet, as preferred or desired.

The integration between the tactile subwoofer component (i) and the speaker component (ii) or the device disclosed herein can be achieved by a number of well-known methods. For example, the signal from the audio source can be split or duplicated, and passed through conventional audio/frequency filters such as, for example, low and high pass filters and like, and amplified and otherwise treated in a variety of ways known to increase the quality of audio signals and sound such as, for example, noise canceling. The object of this manipulation is to obtain two audio streams, one with frequencies from about 5 Hz to about 500 Hz to be transmitted through the tactile subwoofer component (i) and the second, with frequencies from about 20 Hz to about 20 KHz, to be transmitted through the speaker component (ii), preferably with the two streams transmitted to the listeners simultaneously. An example of a simple passive low-pass circuit is given in the attached FIGURE titled “Basic passive low-pass filter layout”. Those skilled in the art will realize that a multitude of techniques are available for separating audio frequencies into various bands including more complex passive filters as well as active designs based on general purpose transistors or op-amps (e.g. NC741), universal filter ICs (e.g. MF10, MAX260 or LTC1060 families) or application specific integrated circuits (ASIC). The use of such filters is preferred both for best efficiency and to minimize the spilling of sound from the personal audio device into the surroundings where it may be heard by others nearby.

In accordance with this invention it is preferred to have a substantial overlap in the frequencies transmitted by the tactile subwoofer component (i) and the speaker component (ii) of the device disclosed herein, where the overlapping frequencies are in the range between the highest frequency transmitter by the said subwoofer component and the lowest frequency transmitted by the said speaker component. It is preferable to have an overlap of about 500 Hz, optionally about 200 Hz, but preferably no less than 100 Hz. Such a preference is related to the sensitivity of the human ear and the human skin. Typically, humans do not hear well in a frequency range below 100 Hz, rarely hear much in a frequency range below 20 Hz, whilst the human skin is sensitive to sound waves above several hertz up to several hundred hertz, with a typical maximum about 250 Hz. Thus, an overlap in the range of frequencies from about 20 Hz to about 500 Hz is preferred. Such overlap may be further enhanced by the application of psychoacoustic techniques wherein the lowest frequencies can be routed only to the tactile sub-woofer, while a particular set of harmonics of those low frequencies can be added to the signal routed to the headphones. In this way, the listener can achieve further appreciation by fulfilling all of the listener's conscious and subconscious sound experience expectations.

The tactile subwoofer component (i) and the speaker component (ii) of the device disclosed herein can be connected to the sound source through conventional wires or via wireless methods, if desired. In the case of wired connection it is preferred to have at least one dedicated connector with the corresponding jack, preferably at least two connectors dedicated to the tactile subwoofer component (i) and the speaker component (ii) respectively as it would enable the listener to control and adjust the tactile subwoofer component (i) and the speaker component (ii) independently and separately, as desired.

In accordance to this invention the output of the tactile subwoofer component (i) and the speaker component (ii) in the device disclosed herein are independently controlled and adjusted. The control button can be located on the components themselves or on the audio source or on both or in any combination as preferred or desired. For example, if the audio source is portable such as, for example, a cell phone or a CD or a MP3 player, it may be preferable to locate the output control buttons on the said portable device itself. If the audio source is stationary such as, for example, a PC or hi-fi or a home theater system, it may be preferable to locate the output control buttons on the said stationary devices or on both the stationary device and the device of the present invention, or in any combination.

It is preferred to have one set of controls for the tactile component (i) and another set of controls for the speaker component (ii) so that the said two components can be controlled and adjusted both independently and separately.

The device of the present invention is wearable as defined herein, preferably relatively light weight, preferably weighing from about 0.1 g to about 200 g, preferably from about 1 g to about 100 g, preferably from about 5 g to about 50 g.

Preferably the two components of the device disclosed herein can be worn separately and independently from each other.

In yet another embodiment this invention provides a method of listening to music and enhancing other audio and audio accompanied experiences in humans, the method comprising:
a) connecting (1) a set of wearable speakers consisting of at least one speaker capable of accurate reproduction of sound with frequencies from about 20 Hz to about 20 KHz and (2) at least one wearable tactile subwoofer capable of accurate reproduction of sound waves with frequencies from about 5 Hz to about 500 Hz, where the said subwoofer is mechanically coupled to the body of the said human
   and
b) simultaneously receiving and independently adjusting the output from the said speaker and the said subwoofer in such a way as to cause no substantial audible interference or disturbance to other humans in a reasonable vicinity, regardless of whether the said humans are also practicing the method or not.

The main distinguishing feature of the method as disclosed herein is that it enables the user to enhance his or her audio and audio accompanied experiences, including but not limited to listening to music, by enjoying all the enhancements and benefits of the low frequency sound, which are typically provided by a subwoofer, personally or in private without sharing it with other people, if so desired, or without disturbing or otherwise distracting other people, if undesirable.

It is well known that live music at various concerts such as, for example, live rock concerts is much enjoyed and appreciated by people, in part because of the powerful subwoofers that are often artificially boosted or otherwise enhanced. Such an experience however, is not private because of the power requirements to drive such subwoofers that make them exceedingly loud.

Various personal audio devices such as, for example, headphones, speakerphones, ear-buds and the like can provide the user with private and personal audio and audio accompanied experience, but because of their limitations in the low frequency range these devices do not create a sensation similar to that that people typically experience when listening to an audio set up which includes a powerful subwoofer, especially a subwoofer that can be controlled and adjusted separately and independently, to further enhance the said audio experience.

The method of the present invention enables the user to draw an experience from listening to music and other audio and audio containing media, which is substantially similar to the experience at live concerts or when the audio media is played on a set up that includes a powerful subwoofer(s) but to experience it personally and in private, if so desired.

The method of the present invention is also distinct and different from the method practiced, when using the vibrating furniture devices and the like. These devices do not necessarily produce loud sound but they produce enough vibration and trembling of, for example, other furniture in the room or in the house, or of the walls or of the floor, depending on how and where these vibrating devices are positioned. The said vibration and trembling is typically sufficient for other people who are in a reasonable vicinity from the user of such vibrators to be disturbed or otherwise distracted, even if the user wares conventional headphones, speakerphones, ear-buds or the like to limit or substantially eliminate the impact of such a disturbance or distraction on the other people.

Various known and available vibrating gaming devices can be used and enjoyed personally or in private without disturbing or otherwise distracting other people, if their use is combined with the use of conventional headphones, speakerphones, ear-buds or the like for reproduction of sound. These devices, however, do not accurately reproduce low frequency sound waves in a typical subwoofer range and, therefore are not used for listening to music and enhancing other audio and audio accompanied experience.

The method of the present invention can be practiced successfully inside a room or a house or an office or any other dwelling suitable for humans, or in a car or in the public transport or in any other containment or outside such dwellings or containments, when standing, sitting, lying or running or being otherwise on the move.

None of the other methods known in the prior art enables such a wide and universal way of listening to music and enhancing other audio and audio accompanied experience without interfering or otherwise disturbing other humans in a reasonable vicinity of the user, as the method of the present invention.

Those skilled of the art as well as many other ordinary people such as disturbed or otherwise distracted parents, or neighbors, or colleagues, or passengers and a variety of others would instantly recognize and appreciate that there are numerous other ways to practice the method of this invention or compel others to practice the said method in addition to the ways mentioned above.

Preferably at least one tactile subwoofer of the method of this invention is the wearable tactile subwoofer of the present invention as disclosed herein.

Preferably a set of wearable speakers and at least one tactile subwoofer of the method of this invention are used in the form of the device of the present invention as disclosed herein.

While the invention has been described with the reference to preferred embodiments it is to be understood that it is not limited to particulars thereof.

### BRIEF DESCRIPTION OF DRAWINGS

The drawing titled “Basic passive low-pass filter layout” is a schematic illustration electronic circuit that can be used to substantially reduce the transmission of frequencies above ˜200 Hz to the subwoofer. The inductor in this circuit is a 3-5 mH wirewound, aircore choke and the capacitor is a 100 mF electrolytic. For simplicity, only one channel is shown, however, in practice, an identical circuit would be employed for the left and right channels in a stereo system. An infinite number of such circuits are possible and this layout is meant only to serve as the minimum circuit to provide suitable low-pass filtering. In fact, even the inductor can be eliminated with some degradation of performance.

The drawing titled “Basic design of a wearable tactile subwoofer system” shows in block diagram form how the subwoofer is used in a complete system. As with the low-pass filter, only one channel is shown for simplicity. In a stereo system, two subwoofers can be used for the two channels, or the low frequency program can be combined and fed to a single tactile subwoofer. The signal to the headphones may optionally have additional signal processing incorporated to further enhance the auditory experience, e.g. psychoacoustic enhancement to provide an additional bass tone perception.

### BEST MODE FOR CARRYING OUT THE INVENTION

A good basic design employs a efficient battery-powered amplifier, suitable sound transducers affixed to the body (e.g. to the chest with an elastic harness similar to a “sportsbra” as a medallion) and connected to an audio source with low-pass filter and headphones as shown in the FIGURE “Basic design of a wearable tactile subwoofer system”. The system described must be powered so as to transfer sufficient low frequency audio waves into the body. The best implementation for portable use will house all of the electronics in a single package such as present day MP3 players or CD players.

### INDUSTRIAL APPLICABILITY

The wearable tactile subwoofer is primarily intended as a novel consumer product and as a component of certain commercial applications e.g. training, immersive systems, and the like.

1: A wearable tactile subwoofer for accurate reproduction of sound frequencies from about 5 Hz to about 500 Hz, where the said subwoofer is mechanically coupled to human body so that attenuation of sound at the interface between the said subwoofer and the body is substantially reduced.

2: The subwoofer as claimed in claim 1, which is mechanically coupled directly to the human skin.

3: The subwoofer as claimed in claim 1, which can be worn as a garment of clothing, or a clothing accessory or a part thereof, or a personal accessory or jewelry.

4: A personal accessory comprising the subwoofer of claim 3, wherein the said accessory is selected from an article of clothing, clothing accessory, personal accessory, piece of jewelry, headband, armband, wristband, skin patch, and medallion.

5: The subwoofer as claimed in claim 1, comprising at least two components; wherein the first component is a coupling component that reduces attenuation of the sound at the interface between the said subwoofer and the body and the second component is an electromechanical device or devices that convert electric signals into mechanical vibrations to generate and transmit sound waves.

6: The subwoofer as claimed in claim 5, wherein the coupling component is elastic and deformable to such an extent as to reasonably conform with curvature of the body.

7: The subwoofer of claim 5, wherein the coupling component is disposable and replaceable.

8: The subwoofer of claim 5, wherein the coupling component is manufactured from materials selected from the group comprising liquid or substantially liquid substances, solid or substantially solid substances, and hydrogels, and any combinations thereof.

9: The subwoofer of claim 5, wherein the second component contains at least one material selected from the group comprising electromagnetic materials, electrostatic materials, piezoelectric materials, and MEMS devices, and any combinations thereof.

10: The subwoofer of claim 5, wherein the two constituent components are detachable and replaceable so that they can be separated or combined into a functional subwoofer.

11: The subwoofer of claim 5, which additionally comprises a third component, wherein said third component is decorative or otherwise esthetically pleasing and that is located at side of the subwoofer that is opposite to the side which is mechanically coupled to the body.

12: The subwoofer of claim 11 wherein the third component is made from a material that can be manufactured in different colors, textures, or shapes; the said material selected from the group comprising plastic, wood, metal, textile, and modifications, and any combinations thereof.

13: The subwoofer of claim 5, wherein at least one of the constituent components is flat.

14: The subwoofer as claimed in claim 13, where the average height of at least one of the constituent components is from about 5 to about 200 times smaller than either the length or width of the said component.

15: The subwoofer of claim 5, where the surface area of at least one of the constituent components is between about 1 cm² to about 2,000 cm².

16: A wearable device for listening to music and for enhancing other audio and audio accompanied experiences; said device comprising:
(i) a tactile subwoofer for accurate reproduction of sound waves with frequencies from about 5 Hz to about 500 Hz, wherein said subwoofer is mechanically coupled to the body, or is part of a garment of clothing, or a clothing accessory, or a personal accessory or jewelry; and
(ii) a set of speakers for accurate reproduction of sound waves with frequencies from 25 about 20 Hz to about 20 KHz;
and wherein
(a) the said tactile subwoofer and the said speakers are connected to the same audio source and transmit the same audio program and
(b) the output from the said subwoofer and speakers can be separately controlled and adjusted with independent output controls.

17: The device as claimed in claim 16, wherein the tactile subwoofer component (i) and the speaker component (ii) are physically contained in different enclosures or housings.

18: The device as claimed in claim 16, where the tactile subwoofer component (i) and the speaker component (ii) are wearable independently and separately.

19: The device as claimed in claim 16, wherein the tactile subwoofer component (i) is coupled to the body at a distance from about a few tenths of an inch to a few feet away from the point where the speaker component (ii) is positioned.

20: The device as claimed in claim 16, where the tactile subwoofer component (i) and the speaker component (ii) are transmitting sound waves at substantially overlapping frequency ranges, and where the said frequency overlap is from about 20 Hz to about 500 Hz.

21: The device as claimed in claim 16, wherein the connection between where the tactile subwoofer component (i) and the speaker component (ii) is selected from the group comprising a wired connection, an optical connection, a wireless connection, and any combinations thereof.

22: The device of the claim 16, where the output controls for the tactile subwoofer component (i) and the speaker component (ii) are located on or near one or more of the said components themselves or the common audio source.

23: The device of the claim 16, where the weight of the device is from about 1 g to about 200 g.

24. (canceled)

25: A method of listening to music and enhancing other audio and audio accompanied experiences in humans, the method comprising:
(i) connecting (1) a set of wearable speakers consisting of at least one speaker capable of accurate reproduction of sound with frequencies from about 20 Hz to about 20 KHz and (2) at least one wearable tactile subwoofer capable of accurate reproduction of sound waves with frequencies from about 5 Hz to about 500 Hz, where the said 25 subwoofer is mechanically coupled to the body of the said human; and
(ii) simultaneously receiving and independently adjusting the output from the said 30 speaker and the said subwoofer in such a way as to cause no substantial audible interference or disturbance to other humans in a reasonable vicinity, regardless of whether the said humans are also practicing the method or not.

26. (canceled)

27. (canceled)
